(19) United States
(12) Patent Application Publication
(10) Pub. No.: US 2019/0248272 A1
(43) Pub. Date: Aug. 15, 2019

(54) LIGHTING DEVICE FOR A VEHICLE AND A METHOD FOR ADJUSTING THE BEAM RANGE OF A HEADLAMP OF A VEHICLE

(71) Applicant: HELLA GMBH & CO. KGAA, Lippstadt (DE)

(72) Inventors: Karol GOLDSCHMIDT, Lippstadt (DE); Frank GRUETER, Lippetal (DE); Stefan LICHTENBERG, Holzwickede (DE); Carsten WILKS, Lippstadt (DE)

(73) Assignee: HELLA GMBH & CO. KGAA, Lippstadt (DE)

(21) Appl. No.: 16/393,444

(22) Filed: Apr. 24, 2019

Related U.S. Application Data
(63) Continuation of application No. PCT/EP2017/076213, filed on Oct. 13, 2017.

(30) Foreign Application Priority Data
Oct. 24, 2016 (DE) 10 2016 120 222.3

(51) Int. Cl. B60Q 1/115; B60Q 1/12

(52) U.S. Cl. CPC B60Q 1/115; B60Q 1/122; F21S 41/675; B60Q 2300/122; B60Q 2300/132

(57) ABSTRACT

A lighting device for a vehicle including a high-resolution headlamp, which has a light influencer for the targeted influencing of individual pixels or groups of pixels of the light emanating from at least one light source and/or a plurality of light sources arranged in a matrix for the targeted generation of individual pixels or groups of pixels of the light emanating from the headlamp during operation, as well as an adjuster for adjusting the beam range of the headlamp which can control the light influencer and/or the light sources for purposes of changing the beam range, wherein the adjuster for adjusting the beam range additionally includes a mechanical adjuster.

This nonprovisional application is a continuation of International Application No. PCT/EP2017/076213, which was filed on Oct. 13, 2017, and which claims priority to German Patent Application No. 10 2016 120 222.3, which was filed in Germany on Oct. 24, 2016, and which are both herein incorporated by reference.

### BACKGROUND OF THE INVENTION

### Field of the Invention

The present invention relates to a lighting device for a vehicle and to a method for adjusting the beam range of a headlamp of a vehicle.

### Description of the Background Art

A lighting device is known from DE 10 2014 105 963 A1, which is incorporated herein by reference. The lighting device described therein comprises as a light source a plurality of light emitting diodes (LED) and an LCD (liquid crystal display). The LCD can selectively affect individual pixels or groups of pixels of the light emanating from at least one light source in order to shift the center of the light emanating from the headlamp. Furthermore, by selective control of light the LCD, the beam range of the headlamp can be changed. In particular, dynamic pitching operations of the vehicle with a small amplitude can be easily compensated by this control.

However, it proves to be very expensive in the conventional art to cover a larger illumination range with such a system, as it for example becomes necessary when loading a vehicle, which causes a great change in inclination. For the conventional systems, to adapt the beam range of the headlamp to such great inclination changes, a very large LCD and a greater number of LEDs would have to be provided. Both of these make the lighting device more complex, resulting in much higher costs.

From DE 10 2012 110 535 A1, a further lighting device is known, with which the beam range of a headlamp can be changed automatically. The lighting device described therein comprises a camera with which the light distribution generated by the headlamp can be detected. By comparing this light distribution with a desired distribution, by controlling servomotors, the lighting range can be adapted to the vehicle state, in particular to the change in inclination of the vehicle due to the addition of greater payloads.

A problem with such mechanical headlamp levelers proves to be that on the one hand, precise headlamp levelers are quite expensive, especially if they are to have a large adjustment range. On the other hand, the life of such headlamp levelers is also limited if a highly dynamic regulation of the lighting range is to take place.

### SUMMARY OF THE INVENTION

It is therefore an object of the present invention to provide.a lighting device that provides an adjustment of the beam range to different situations with less effort and in a or more cost-effective manner. Furthermore, a method is provided which provides an adjustment of the beam range to different situations with less effort and/or in a more cost-effective manner.

In an exemplary embodiment, it is provided that an adjuster for adjusting the lighting range additionally comprise a mechanical adjuster. This makes it is possible to utilize the advantages of the two different adjustment options. In particular, the type of adjustment can be selected based on the change in the beam range that is to be made. For example, the loading of a vehicle usually leads to a large, comparatively static inclination change, which can be compensated via the mechanical adjuster, whereas rather highly dynamic changes occurring during driving due to acceleration and/or braking events can be better compensated by the control of the light influencer or the light sources of the headlamp. It is, however, certainly possible to change the beam range by controlling both the mechanical adjuster and the light influencer or the light sources of the headlamp.

It can be provided that the light influencer are embodied as a DMD (digital micromirror device) or as an LCD or as an LCoS (Liquid Crystal on Silicon) or as laser scanners. With these light influencing agents, the light distribution can be adjusted very quickly to the current vehicle state. The adjustment can be made, for example, by the targeted control of individual mirrors of a DMD chip. In a laser scanner, for example, a fine adjustment of the beam range can be made by changing the scan area and/or by changing the scan frequency and/or by changing the control times of the laser.

Alternatively, or additionally, it may be provided that the light sources are designed as light emitting diodes or as laser diodes, wherein, for example, the LEDs or laser diodes are arranged in a matrix or wherein, for example, the light emitting diodes are integrated in a solid-state LED array. Also, by choosing such light sources, the light distribution can be adjusted very quickly to the current vehicle state, in particular in that individual light sources are selectively controlled.

There is the possibility that the mechanical adjuster allows for a pivoting or shifting of the headlamp or the light-generating parts of the headlamp, in particular in the vertical and/or horizontal direction. It can be provided that the mechanical adjuster engages in a light module and pivot this as a whole, relative to the headlamp housing or a support frame arranged therein. But there is also the possibility that the mechanical adjuster engages in a smaller unit. For example, in a system with a laser scanner, it is sufficient if the position of a converter such as a phosphor converter, and optional subsequent projection optics, is changed via the mechanical adjuster, and the scanning mirror deflects the laser light accordingly.

The mechanical adjuster can comprise at least one motor, for example, a DC motor or a stepping motor. In particular, a DC motor provides a very cost-effective alternative. Unlike with other known systems, a DC motor does not provide a very precise adjustment of the beam range or the swivel angle. However, with the combined use of both adjustment options, this is not necessary because the beam range or the pivot angle can be precisely adjusted by the control of the light influencer or of the light sources of the headlamp. This way, a particularly favorable and durable overall system can be realized.

It can be provided that the adjuster for adjusting the beam range can include a sensor, for example, at least one inclination sensor and/or at least one camera, which can detect an inclination of the vehicle and/or the change in position of the headlamp, in particular the change in the position of the light influencer or the plurality of light sources. In particular, the adjuster for adjusting the beam range may comprise a controller which, for changing the lighting range, can control the light influencer and/or the light sources and/or the mechanical adjuster. In this case, the controller can adjust the beam range as a function of the detected inclination of the vehicle and/or the changed position of the headlamp. Preferably, based on the state of the vehicle detected by the sensor, the controller can selectively determine whether to adjust the beam range by controlling the mechanical adjuster or by controlling the light influencer or the light sources of the headlamp or by using both adjustment options.

It is also provided that, as a function of the detected operating situation and/or the detected change in inclination of the vehicle, the beam range can be adjusted by controlling the mechanical adjuster and/or by controlling the light influencer and/or via the light sources. In particular, the mechanical adjuster can be controlled when an inclination or pivoting angle of the change in inclination is greater than a specified inclination or pivoting angle, and/or the frequency of the inclination change is smaller than a specified frequency. This is in particular the case because with large adjustment ranges and slow changes in inclination, the mechanical adjuster is more suited to the adjustments that are to be made.

Accordingly, at an inclination or pivoting angle of the change in inclination smaller than a specified inclination or pivoting angle, and/or with a frequency of the change in inclination greater than a specified frequency, the light influencer, or the light sources of the headlamp can be controlled. This is because in the case of small adjustments and fast changes in inclination, the control of the light influencer, or the light sources of the headlamp is more suitable for the adjustments to be made.

It can further be provided that apart from the horizontal or vertical adjustment option by the mechanical adjuster and the control of the light influencer or the light sources of the headlamp, no further adjustment options, for example for a default setting, are available. Accordingly, a default setting of the headlamp can also be performed via the mechanical adjuster and via a control of the light influencer or the light sources of the headlamp. The greater portion of the adjustment range can be provided by the mechanical adjuster in order to be able to provide a favorable overall system. The fact that the mechanical adjuster may no longer allow for such precise adjustments is compensated by the possibility of controlling the light influencer or the light sources of the headlamp.

It can be provided that when using a lighting device according to the invention, no sensors are needed for the position feedback of the mechanical adjuster. This also allows for the mechanical tolerances in the system to be bypassed. In this way, the high precision necessary to operate high-resolution headlamp systems can be achieved.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawing which are given by way of illustration only, and thus, are not limitive of the present invention, and wherein: the sole FIGURE is a schematic sketch of an exemplary embodiment of a lighting device according to the invention.

### DETAILED DESCRIPTION

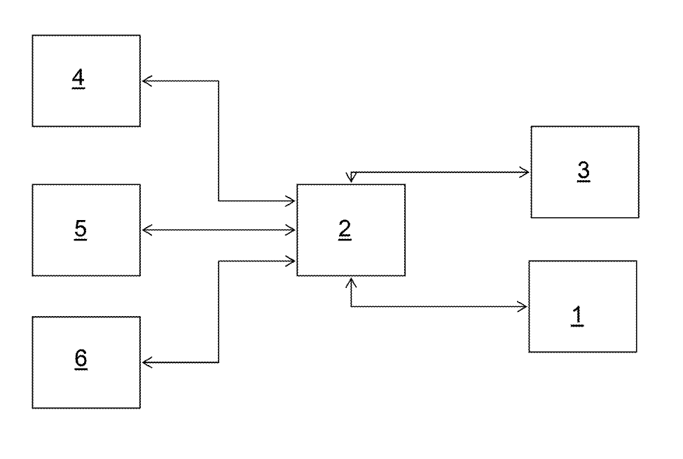

The embodiment schematically indicated in FIG. 1 of an inventive lighting device comprises a high-resolution headlamp 1 which may have at least one light source, for example embodied as at least one light emitting diode or laser diode, and a light influencer for the purposeful influencing of individual pixels or groups of pixels of the light emanating from the at least one light source. The light influencer may be designed as a DMD or as an LCD or as an LCoS or as a laser scanner.

Alternatively, or additionally, the headlamp may have a plurality of light sources arranged in a matrix for the targeted generation of individual pixels or groups of pixels of the light emanating from the headlamp during operation. In this case, the light sources can be designed as light emitting diodes or as laser diodes, wherein, for example, the light emitting diodes or laser diodes are arranged in a matrix or wherein, for example, the light emitting diodes are integrated in a solid-state LED array.

The illustrated embodiment further comprises a controller 2 which can control the light influencer and/or the light sources of the headlamp 1 to adjust the beam range. The controller 2 may be designed, for example, as an ECU (Electronic Control Unit). In particular, the controller 2 can selectively switch individual pixels of the light to be generated by the headlamp on or off, or change their brightness in a targeted manner, for example by switching individual LEDs on or off or by dimming them. In this way, the beam range of the headlamp can be adjusted.

The illustrated embodiment further comprises a mechanical adjuster 3, which can also be used to adjust the beam range of the headlamp 1. The mechanical adjuster 3 can facilitate a pivoting or shifting of the headlamp 1 or of light-generating parts of the headlamp 1, in particular in the vertical and/or horizontal direction.

It can be provided that the mechanical adjuster engages with a light module and pivot this as a whole, relative to the headlamp housing or a support frame arranged therein. But there is also the possibility that the mechanical adjuster engages with a smaller unit. For example, in a system with a laser scanner, the mechanical adjuster can change the position of a converter such as a phosphor converter and the position of an optional subsequent projection optics, wherein a scanning mirror deflects the laser light accordingly.

The mechanical adjuster can comprise at least one motor, which is designed, for example, as a DC motor. The motor can be selectively controlled by the controller 2 to pivot or shift the headlamp 1 or the light-generating parts of the headlamp 1.

The controller 2 may communicate with various sensors. In FIG. 1, an exemplary sensor 4 is formed as an axle sensor, the sensor 5 can be designed as a camera and a sensor 6 for state detection are shown.

The sensor 4 designed as an axle sensor can be used, for example, as an inclination sensor to detect the inclination of the vehicle. The sensor 6 for state detection can, for example, be designed as an acceleration sensor and/or as a position sensor. There is also the option of using other sensors of the vehicle to determine speed, steering angle or curve radius. There is also the possibility to provide a light sensor which detects the light emanating from the light-generating parts of the headlamp.

The sensor 5 designed as a camera can detect the light distribution generated by the headlamp 1 on the roadway. From this, the controller 2 can determine the current state of the vehicle, in particular the inclination angle of the vehicle.

As a function of the determined state of the vehicle, the controller 2 can control either the mechanical adjuster 3 or the light influencer or the light sources of the headlamp 1 in order to adjust the beam range of the headlamp 1 to the determined state of the vehicle. Alternatively, the controller 2 can control both the mechanical adjuster 3 and the light influencer or the light sources of the headlamp 1.

The two adjustment options, on the one hand via the control of the mechanical adjuster 3, or the light influencer or the light sources of the headlamp 1 on the other, differ in their properties, such as dynamics, achievable adjustment, achievable adjustment angle and accuracy. For example, the light image can be adjusted very quickly via a correspondingly adjusted control of the light influencer or of the light sources of the headlamp 1.

However, it may be very elaborate to realize large adjustments or large adjustment angles solely by controlling the light influencer or the light sources of the headlamp 1. Large adjustments or adjustment angles are easier to obtain by using the mechanical adjuster 3.

It is therefore possible to let the controller 2 determine, based on suitable parameters, which of the two adjustment options is more appropriate for the current, detected vehicle state. Possible parameters for determining as to whether compensation occurs using the control of the mechanical adjuster 3 on the one hand, or the light influencer or the light sources of the headlamps 1 on the other, may be the absolute value of the inclination or pivoting angle, the operating situation, or the frequency of the detected change in inclination.

For example, loading a vehicle usually leads to a large change in inclination, which, however, is quasi-static. Thus, this can be easily intercepted by the mechanical adjuster 3. By contrast, during driving, highly dynamic yet slight changes in inclination are more likely to occur due to acceleration and/or braking events. These can be easily balanced by controlling the light influencer or the light sources of the headlamp 1.

Accordingly, for example, a limit amplitude can be specified, wherein the mechanical adjuster 3 are only controlled when this limit is exceeded. Furthermore, for example, a cutoff frequency can also be specified, wherein the mechanical adjuster 3 is controlled only when this limit is exceeded. Inclination compensation may be in this case be carried out solely by the mechanical adjuster 3. But it can also be provided that in addition, a fine adjustment of the image is made by the appropriate control of the light influencer or the light sources of the headlamp 1.

The invention being thus described, it will be obvious that the same may be varied in many ways. Such variations are not to be regarded as a departure from the spirit and scope of the invention, and all such modifications as would be obvious to one skilled in the art are to be included within the scope of the following claims

What is claimed is:

1. A lighting device for a vehicle, the lighting device comprising:
a high-resolution headlamp that has a light influencer to selectively influence individual pixels or groups of pixels of light emanating from at least one light source and/or a plurality of light sources arranged in a matrix for the targeted generation of individual pixels or groups of pixels of the light emanating from the headlamp during operation; and
an adjuster to adjust a beam range of the headlamp, which controls the light influencer and/or the light sources for the modification of the beam range;
wherein the adjuster comprise a mechanical adjuster.

2. The lighting device according to claim 1, wherein the light influencer is a DMD, an LCD, an LCoS, or a laser scanner.

3. The lighting device according to claim 1, wherein the light sources are light emitting diodes or laser diodes, wherein the light emitting diodes or laser diodes are arranged in a matrix, or wherein the light emitting diodes are integrated in a solid-state LED array.

4. The lighting device according to claim 1, wherein the mechanical adjuster allows for a pivoting or shifting of the headlamp or light-generating components of the headlamps in a vertical and/or a horizontal direction.

5. The lighting device according to claim 1, wherein the mechanical adjuster comprises at least one motor formed as a DC motor or a stepping motor.

6. The lighting device according to claim 1, wherein the adjuster for adjusting the beam range includes a sensor or at least one inclination sensor and/or at least a camera, which detects an inclination of the vehicle and/or a change in the position of the headlamp or a change in the position of the light influencer or the plurality of light sources.

7. The lighting device according to claim 1, wherein the adjuster for adjusting the beam range includes a controller, which controls the light influencer and/or the light sources and/or the mechanical adjuster to change the beam range.

8. The lighting device according to claim 7, wherein the controller adjusts the beam range as a function of the detected inclination of the vehicle and/or the change in position of the headlamp.

9. A method for adjusting a beam range of a headlamp of a vehicle with a lighting device according to claim 1, the method comprising:
detecting an operating state and/or a change in an inclination of the vehicle;
adjusting the beam range as a function of the detected operating situation and/or the detected change in the inclination of the vehicle by controlling a mechanical adjuster and/or by controlling a light influencer and/or light sources.

10. The method according to claim 9, wherein, at an inclination angle or pivoting angle of the inclination change, which is greater than a specified inclination angle or pivoting angle, and/or that at a frequency of the inclination change, which is smaller than a specified frequency, the mechanical adjuster is controlled.
